(19) United States
(12) Patent Application Publication
(10) Pub. No.: US 2024/0171005 A1
(43) Pub. Date: May 23, 2024

(54) ENERGY STORAGE SYSTEM BASED ON HYDROGEN-OXYGEN COMBUSTION TECHNOLOGY AND OPERATION METHOD THEREFOR

(71) Applicant: Marvel-Tech Ltd., Shanghai (CN)

(72) Inventors: Yifeng Chen, Shanghai (CN); Gang Lin, Shanghai (CN); Wencheng Jiang, Shanghai (CN)

(21) Appl. No.: 18/127,369

(22) Filed: Mar. 28, 2023

(30) Foreign Application Priority Data
Nov. 21, 2022 (CN) 202211454024.5

(51) Int. Cl. H02J 15/00; C25B 1/04

(52) U.S. Cl. CPC H02J 15/008; C25B 1/04

(57) ABSTRACT

Excess electric energy or unstable electric energy in a renewable energy power generation device is processed through a water electrolysis device for hydrogen production to generate hydrogen and oxygen for energy storage, and the hydrogen can be output to an external demand end or generate green hydrogen and green ammonia for energy storage and utilization. The embodiment is further provided with a hydrogen-oxygen combustion device and a turbine power generation device, wherein the turbine power generation device can select a high-temperature and high-pressure gas output from the hydrogen-oxygen combustion device to generate electricity, or select a normal-temperature and high-pressure oxygen directly output from an oxygen storage unit to generate the electricity so that the generated electric energy can be output to a grid-connected end or to the water electrolysis device for hydrogen production and a liquid air separation device.

### CROSS REFERENCE TO RELATED APPLICATIONS

This application claims priority of Application No. CN 202211454024.5 filed in China on Nov. 21, 2022 under 35 U.S.C. § 119, the entire contents of all of which are hereby incorporated by reference.

### FIELD OF THE INVENTION

The invention relates to the technical field of energy storage systems, in particular, to an energy storage system based on hydrogen-oxygen combustion technology and an operation method therefor.

### DESCRIPTION OF THE PRIOR ART

In recent years, the wind power and solar power generation in China have developed rapidly. The national grid-connected wind power has an installed capacity of 281 million kilowatts, and the photovoltaic power generation has an installed capacity of 253 million kilowatts. In 2020 alone, the newly installed capacity of wind power was 71.67 million kilowatts with a year-on-year increase of 178.4%, and the newly installed photovoltaic capacity was 48.2 million kilowatts with a year-on-year increase of 60.1%. However, affected by geographical location, weather, environment, and other factors, wind power and solar power generation have the characteristics of intermittent and reverse peak regulation, which seriously affects the stability of the power grid and results in a very prominent phenomenon of wind and solar curtailments, thereby causing much energy to be wasted.

In order to solve this problem, electric energy storage technology can be adopted, i.e., storing the excess wind power and solar power generated during the valley of electricity consumption to be used again at the peak of electricity consumption. At present, the more mature energy storage methods are physical energy storage, including pumped storage, compressed-air energy storage, and flywheel energy storage. Pumped storage and compressed-air energy storage have very high requirements in the geographical environment and are difficult to build in large quantities. Although flywheel energy storage is highly efficient, it has problems such as small storage capacity and high technical requirements. In recent years, due to the advantages of high energy density and large storage capacity, hydrogen energy storage has become an energy storage method with great development potential. Hydrogen energy storage is to use the water electrolysis device to convert curtailed electricity by wind and PV into hydrogen and oxygen for storage, and use the stored hydrogen for power generation when the power generation by wind and PV does not meet the load demand.

At present, for the most efficient electric energy storage technology, the mainstream solution is to use hydrogen combustion to convert it into electric energy through a heat engine to compensate for the shortcomings of renewable energy, such as intermittency, randomness, and volatility. However, the existing energy storage system using hydrogen combustion for power generation mainly adopts a closed recirculating system, which is vast and complicated. At the same time, due to the complexity of the system, long start and stop time of the system, the poor ability of peak shaving and valley filling, and the narrow power load of the closed recirculation, the flexibility of the whole system is poor.

### SUMMARY OF THE INVENTION

In order to solve the above problems, the invention provides an energy storage system based on hydrogen-oxygen combustion technology and an operation method therefor, which has the following technical solutions:

An energy storage system based on hydrogen-oxygen combustion technology includes:

a renewable energy power generation device;

a water electrolysis device for hydrogen production, with an electric energy input end connected with an electric energy output end of the renewable energy power generation device;

a hydrogen storage unit, with an input end connected with a hydrogen output end of the water electrolysis device for hydrogen production, and a first output end used to be connected with an external hydrogen demand end;

an oxygen storage unit, with an input end connected with an oxygen output end of the water electrolysis device for hydrogen production;

a hydrogen-oxygen combustion device, with a hydrogen input end connected with a second output end of the hydrogen storage unit, and an oxygen input end connected with a first output end of the oxygen storage unit for mixed combustion of inputted hydrogen and oxygen and outputting a high-temperature and high-pressure gas;

a turbine power generation device, with a first input end connected with an output end of the hydrogen-oxygen combustion device for receiving the high-temperature and high-pressure gas and performing expansion to generate power, a second input end connected with a second output end of the oxygen storage unit for receiving a high-pressure oxygen output by the oxygen storage unit and performing expansion to generate power, and an electric energy output end connected with the water electrolysis device for hydrogen production;

a grid-connected end, with an electric energy input end connected with the electric energy output end of the renewable energy power generation device and the electric energy output end of the turbine power generation device respectively, and with an electric energy output end connected with an external power grid;

an ammonia synthesis device, with a hydrogen input end connected with a third output end of the hydrogen storage unit for generating gaseous ammonia and outputting to an external ammonia demand end.

The energy storage system based on hydrogen-oxygen combustion technology of the invention includes an air separation unit for separating oxygen and nitrogen from air;

an electric energy end of the air separation unit is connected with the electric energy end of the grid-connected end;

an oxygen output end of the air separation unit is connected with an input end of the hydrogen-oxygen combustion device;

a first nitrogen output end of the air separation unit is connected with a nitrogen input end of the ammonia synthesis device, and a second nitrogen output end of the air separation unit is connected with the turbine power generation device.

For the energy storage system based on hydrogen-oxygen combustion technology of the invention, the turbine power generation device includes a turbine machine, a nitrogen replacement device and a nitrogen thermal management device;

a compressed gas inlet of the turbine machine is connected with the output end of the hydrogen-oxygen combustion device and the second output end of the oxygen storage unit;

input ends of the nitrogen replacement device and the nitrogen thermal management device are connected with the second nitrogen output end of the air separation unit respectively;

an output end of the nitrogen replacement device is connected with the compressed gas inlet of the turbine machine for replacing a gas in the turbine machine;

an output end of the nitrogen thermal management device is connected with a rotor and a casing of the turbine machine for adjusting a rotational-static clearance of the turbine machine.

For the energy storage system based on hydrogen-oxygen combustion technology of the invention, the turbine machine includes the casing, a Vane carrier and a rotor shaft;

the Vane carrier is disposed in the casing, the Vane carrier forms a turbine chamber, and a hollow chamber is formed between the Vane carrier and the casing; a plurality of stationary blades are arranged at intervals in the Vane carrier and cooperate with each other to form a plurality of rotor blade accommodating cavities;

a head end of the casing is provided with the compressed gas inlet connected with the turbine chamber;

the rotor shaft is rotatably connected in the turbine chamber through a first bearing end and a second bearing end;

the rotor shaft is provided with rotor blades corresponding to the rotor blade accommodating cavities;

a rotational-static clearance is formed between a tip of the rotor blade and an inner wall surface of the turbine chamber, and between a bottom of the stationary blade and the rotor shaft;

wherein the hollow chamber is connected with the output end of the nitrogen thermal management device for outputting nitrogen at a corresponding temperature to control a thermal expansion and contraction volume of the casing and the Vane carrier, so as to adjust the rotational-static clearance between the inner wall surface of the turbine chamber and the tip of the rotor blade;

the rotor shaft is provided inside with a rotor hollow chamber, the first bearing end is provided with a gas channel connected with the rotor hollow chamber, and an input end of the gas channel is connected with the output end of the nitrogen thermal management device for outputting nitrogen at the corresponding temperature to control a thermal expansion and contraction volume of the rotor shaft so as to adjust the rotational-static clearance between the tip of the rotor blade and the inner wall surface of the turbine chamber and between the bottom of the stationary blade and the rotor shaft.

For the energy storage system based on hydrogen-oxygen combustion technology of the invention, the rotor blades and the rotor shaft are made of nickel-based materials.

For the energy storage system based on hydrogen-oxygen combustion technology of the invention, the first bearing end and the second bearing end are provided with a hydraulic fine-tuning system and a bearing chamber oil feeding and recirculating system, the hydraulic fine-tuning system is used to adjust an axial position of the rotor shaft, and the bearing chamber oil feeding and recirculating system is used to output a lubricating oil with a stable temperature to maintain a bearing operation environment temperature in the first bearing end and the second bearing end.

For the energy storage system based on hydrogen-oxygen combustion technology of the invention, a front side and a rear side of the first bearing chamber of a first bearing end are respectively provided with a graphite ring sealing structure, and the gas channel is located between the graphite ring sealing structures on the front side and the rear side;

a second bearing chamber of the second bearing end is provided with a labyrinth sealing structure on a side close to the turbine chamber and the graphite ring sealing structure on a side away from the turbine chamber respectively, and the labyrinth sealing structure is used to adjust a gap between the labyrinth sealing structure and the rotor shaft to control mass flow in the rotor hollow chamber.

For the energy storage system based on hydrogen-oxygen combustion technology of the invention, the air separation unit includes a liquid air separation device, a first air-pressure booster, a second air-pressure booster, a liquid oxygen evaporator and a liquid nitrogen evaporator;

a liquid oxygen output end of the liquid air separation device is provided with the first air-pressure booster and the liquid oxygen evaporator in sequence, and an output end of the liquid oxygen evaporator is connected with the input end of the hydrogen-oxygen combustion device;

a liquid nitrogen output end of the liquid air separation device is provided with the second air-pressure booster and the liquid nitrogen evaporator in sequence, and an output end of the liquid nitrogen evaporator is connected with the nitrogen input end of the ammonia synthesis device and the turbine power generation device respectively.

For the energy storage system based on hydrogen-oxygen combustion technology of the invention, the hydrogen-oxygen combustion device includes a burner, an axial hydrogen nozzle, a radial hydrogen nozzle, a flame tube and a blender;

the flame tube is disposed in the burner, an interior of the flame tube is a flame combustion area, an oxygen inflow channel is formed between the flame tube and an inner wall of the burner, and an input end of the oxygen inflow channel is connected with the first output end of the oxygen storage unit;

an input end of the axial hydrogen nozzle is connected with the second output end of the hydrogen storage unit, and an output end of the axial hydrogen nozzle passes through the burner to extend into the flame combustion area;

an input end of the radial hydrogen nozzle is connected with the second output end of the hydrogen storage unit, an output end of the radial hydrogen nozzle passes through the burner to extend into the flame combustion area, and the radial hydrogen nozzle is disposed around the axial hydrogen nozzle;

an output end of the radial hydrogen nozzle forms a first injection area in the flame tube, the output end of the axial hydrogen nozzle forms a second injection area in the flame tube, and the first injection area is closer to a head end of the flame tube relative to the second injection area in an axial direction;

the flame tube is provided with an oxygen output hole connected with the first injection area and an oxygen output hole of the oxygen inflow channel;

a high-temperature gas input end of the blender is connected with an output end of the flame tube, an oxygen input end of the blender is connected with the first output end of the oxygen storage unit, and an output end of the blender is connected with the first input end of the turbine power generation device.

An operation method of the invention is applied to the energy storage system based on hydrogen-oxygen combustion technology according to any one of the above items, wherein when a generating capacity of the renewable energy power generation system is stable and meets an electric energy load of the water electrolysis device for hydrogen production, and when the external power grid does not need peak regulation, the renewable energy power generation system supplies the electricity independently, the hydrogen and the oxygen generated by the water electrolysis device for hydrogen production are respectively stored in the hydrogen storage unit and the oxygen storage unit for long-term storage, and the hydrogen in the hydrogen storage unit may be output to the external hydrogen demand end;

when the generating capacity of the renewable energy power generation system is stable and meets the electric energy load of the water electrolysis device for hydrogen production, and when the external power grid needs peak regulation, the renewable energy power generation system supplies the electricity for the water electrolysis device for hydrogen production, and the turbine power generation device selects the high-temperature and high-pressure gas after hydrogen-oxygen combustion for expansion and power generation or a high-pressure and normal-temperature pure oxygen output from the oxygen storage unit for expansion and power generation according to a peak regulating load and outputs the electric energy to the grid-connected end;

when the generating capacity of the renewable energy power generation system is stable and does not meet the electric energy load of the water electrolysis device for hydrogen production, the renewable energy power generation system and the turbine power generation device supply the electricity simultaneously, the hydrogen storage unit and the oxygen storage unit output the hydrogen and the oxygen to the hydrogen-oxygen combustion device for combustion to form the high-temperature and high-pressure gas, and the turbine power generation device receives the high-temperature and high-pressure gas for expansion and power generation to supplement a remaining electric energy load required by the water electrolysis device for hydrogen production;

when the generating capacity of the renewable energy power generation system is stable and does not meet the electric energy load of the water electrolysis device for hydrogen production, the renewable energy power generation system and the turbine power generation device supply the electricity simultaneously, and the oxygen storage unit outputs the high-pressure and normal-temperature pure oxygen to the turbine power generation device for expansion and power generation to supplement the remaining electric energy load required by the water electrolysis device for hydrogen production;

when the generating capacity of the renewable energy power generation system is not stable, the turbine power generation device supplies the electricity for the water electrolysis device for hydrogen production, the hydrogen storage unit and the oxygen storage unit output the hydrogen and the oxygen to the hydrogen-oxygen combustion device for combustion to form the high-temperature and high-pressure gas, and the turbine power generation device receives the high-temperature and high-pressure gas for expansion and power generation and outputs the electric energy to the water electrolysis device for hydrogen production.

Due to the adoption of the above technical solutions, the invention has the following advantages and beneficial effects as compared with the prior art:

1. According to an embodiment of the invention, excess electric energy or unstable electric energy in a renewable energy power generation device is processed through a water electrolysis device for hydrogen production to generate hydrogen and oxygen for energy storage, and the hydrogen can be output to an external demand end or generate green hydrogen and green ammonia for energy storage and utilization. The embodiment is further provided with a hydrogen-oxygen combustion device and a turbine power generation device, wherein the turbine power generation device can select a high-temperature and high-pressure gas output from the hydrogen-oxygen combustion device to generate electricity, or select a normal-temperature and high-pressure oxygen directly output from an oxygen storage unit to generate the electricity so that the generated electric energy can be output to a grid-connected end or to the water electrolysis device for hydrogen production and a liquid air separation device, which has a very strong flexibility, can provide power in a wide load range to adapt to a wider peaking demand of a power grid, and can maintain the stability in the energy storage of the overall system under extreme external environmental conditions.

At the same time, since the turbine power generation device of the system is of an open recirculation, the power generation load may be quickly increased to provide guarantees for system stability and power grid peak regulation.

2. According to an embodiment of the invention, the air separation unit is further provided, which may independently provide the gaseous nitrogen required for the preparation of green ammonia for the ammonia synthesis device in the energy storage system, and may independently supplement the nitrogen required by the nitrogen thermal management device and replacement device in the turbine power generation unit without the need to introduce additional nitrogen from outside the system. At the same time, the reaction by-product liquid oxygen may also be used to be converted into high-pressure oxygen through the air-pressure booster and the liquid oxygen evaporator, which are sent to the hydrogen-oxygen combustion device and the turbine power generation device for peak regulation or to make up for the power gap of the system.

3. According to an embodiment of the invention, for the design of the hydrogen-oxygen combustion device, through the technical characteristics of staged combustion and the design of a counter-flow oxygen channel, it can ensure that the temperature field of the burner is evenly distributed and meet the resistance characteristics of existing materials.

4. According to an embodiment of the invention, compared with traditional thermal power generation and thermal power peak regulating devices, due to the combustion reaction of pure hydrogen and pure oxygen and the only product of water vapor generated by the combustion reaction, the energy storage system does not have any pollutants such as carbon oxides, nitrogen oxides, and sulfides, thereby achieving true zero emissions. At the same time, the conversion efficiency of the power generation of the energy storage system is very high, wherein by adjusting the proportion of hydrogen mixed combustion, the conversion efficiency of the energy storage may reach more than 80%.

### BRIEF DESCRIPTION OF THE DRAWINGS

FIG. 1 is a diagram of an energy storage system based on hydrogen-oxygen combustion technology according to the invention;

FIG. 2 is a diagram of a turbine power generation device of the energy storage system based on hydrogen-oxygen combustion technology according to the invention;

FIG. 3 is a diagram of a hydrogen-oxygen combustion device of the energy storage system based on hydrogen-oxygen combustion technology according to the invention.

Description of reference numerals: 1: Renewable energy power generation device; 2: Water electrolysis device for hydrogen production; 3: Hydrogen storage unit; 4: Oxygen storage unit; 5: Hydrogen-oxygen combustion device; 6: Turbine power generation device; 7: Ammonia synthesis device; 8: Grid-connected end; 9: Liquid air separation device; 10: First air pressure booster; 11: Liquid oxygen evaporator; 12: Second air pressure booster; 13: Liquid ammonia evaporator; 14: Nitrogen replacement device; 15: Nitrogen thermal management device; 16: Shell; 17: Vane carrier; 18: Hollow chamber; 19: Rotor shaft; 20: Rotor hollow chamber; 21: First bearing end; 22: Second bearing end; 23: Gas channel; 24: Rotor blade; 25: Blender; 26: Burner; 27: Axial hydrogen nozzle; 28: Radial hydrogen nozzle: 29: Flame tube.

### DESCRIPTION OF THE PREFERRED EMBODIMENTS

The energy storage system based on the hydrogen-oxygen combustion technology and the operation method therefor proposed by the invention will be further described in detail below with reference to the drawings and specific embodiments. The advantages and features of the invention will be apparent from the following description and claims.

### Embodiment One

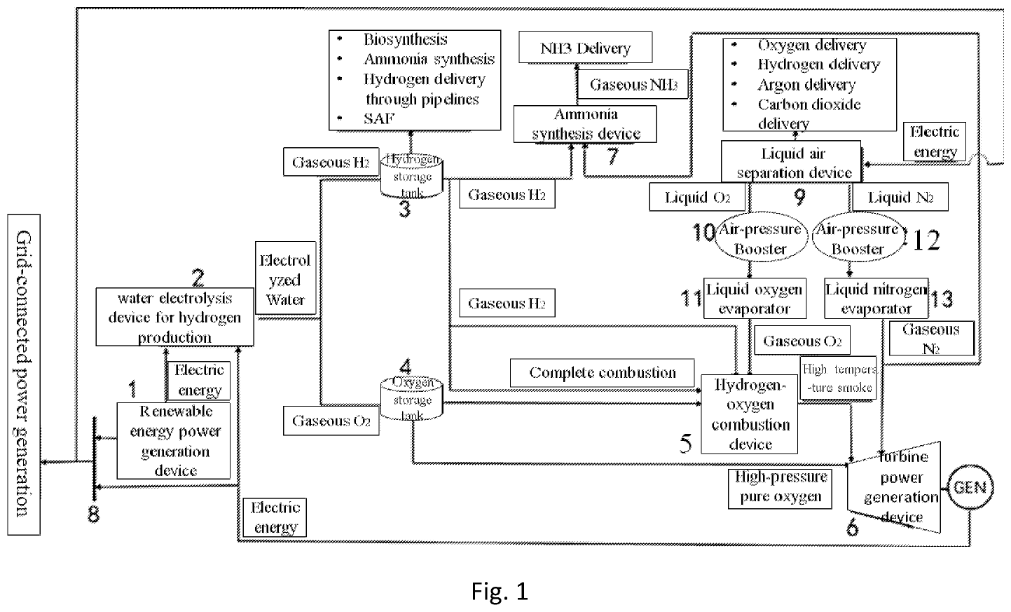

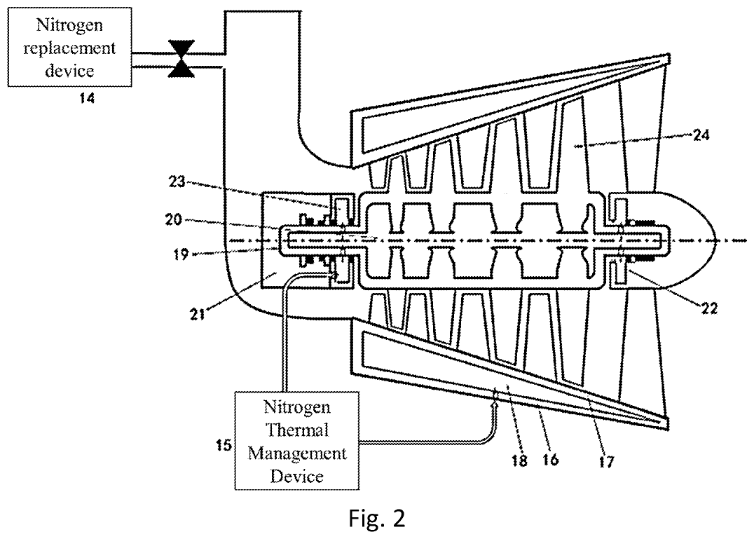

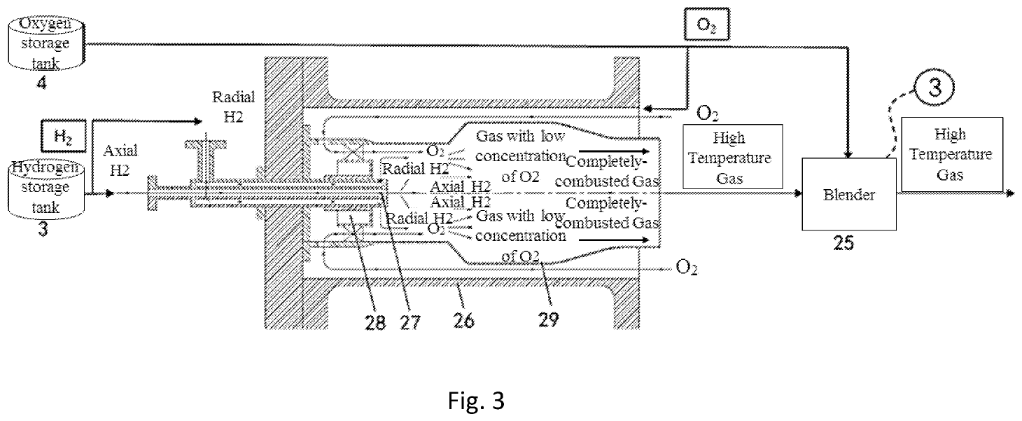

With reference to FIGS. 1 to 3, in an embodiment, an energy storage system based on the hydrogen-oxygen combustion technology includes a renewable energy power generation device 1, a water electrolysis device for hydrogen production 2, a hydrogen storage unit 3, an oxygen storage unit 4, a hydrogen-oxygen combustion device 5, a turbine power generation device 6, a grid-connected end 8, and an ammonia synthesis device 7.

The water electrolysis device for hydrogen production 2 has an electric energy input end connected with an electric energy output end of the renewable energy power generation device 1.

The hydrogen storage unit 3 (may be a hydrogen storage tank or other hydrogen storage devices) has an input end connected with a hydrogen output end of the water electrolysis device for hydrogen production 2, and a first output end of the hydrogen storage unit 3 is used to be connected with an external hydrogen demand end (such as biosynthesis, ammonia synthesis, hydrogen delivery through pipeline network, SAF, etc.). The oxygen storage unit 4 (may be an oxygen storage tank or other oxygen storage devices) has an input end connected with an oxygen output end of the water electrolysis device for hydrogen production 2.

The hydrogen-oxygen combustion device 5 has a hydrogen input end connected with a second output end of the hydrogen storage unit 3, and an oxygen input end of the hydrogen-oxygen combustion device 5 is connected with a first output end of the oxygen storage unit 4 for mixed combustion of input hydrogen and oxygen and outputting a high-temperature and high-pressure gas.

The turbine power generation device 6 has a first input end connected with an output end of the hydrogen-oxygen combustion device 5 for receiving the high-temperature and high-pressure gas and performing expansion to generate power. The turbine power generation device 6 has a second input end connected with a second output end of the oxygen storage unit 4 for receiving a high-pressure oxygen output by the oxygen storage unit 4 and performing expansion to generate power. An electric energy output end of the turbine power generation device 6 is connected with the water electrolysis device for hydrogen production 2 for supplying the electricity to the water electrolysis device for hydrogen production 2 when the power generation of the renewable energy power generation device 1 is unstable so as to maintain the stable operation of the energy storage system.

A grid-connected end 8 has an electric energy input end connected with an electric energy input end of the renewable energy power generation device 1 and the electric energy output end of the turbine power generation device 6 respectively, and an electric energy output end of the grid-connected end 8 is connected with an external power grid.

An ammonia synthesis device 7 has a hydrogen input end connected with a third output end of the hydrogen storage unit 3 for receiving the hydrogen output by the hydrogen storage unit 3 to generate gaseous ammonia and output to an external ammonia demand end.

According to the embodiment, excess electric energy or unstable electric energy in the renewable energy power generation device 1 is processed through the water electrolysis device for hydrogen production 2 to generate hydrogen and oxygen for energy storage, and the hydrogen can be output to an external demand end or generate green hydrogen and green ammonia for energy storage and utilization. The embodiment is further provided with the hydrogen-oxygen combustion device 5 and the turbine power generation device 6, wherein the turbine power generation device 6 may select a high-temperature and high-pressure gas output from the hydrogen-oxygen combustion device 5 to generate electricity, or select a normal-temperature and high-pressure oxygen directly output from the oxygen storage unit 4 to generate the electricity so that the generated electric energy may be output to the grid-connected end 8 or to the water electrolysis device for hydrogen production 2, which has a very strong flexibility, can provide power in a wide load range to adapt to a wider peaking demand of a power grid, and can maintain the stability in the energy storage of the overall system under extreme external environmental conditions.

At the same time, since the turbine power generation device 6 of the system is of an open recirculation, the power generation load may be quickly increased to provide guarantees for system stability and power grid peak regulation.

The energy storage system based on hydrogen-oxygen combustion technology according to the embodiment is further described as follows.

In the embodiment, the energy storage system may further include an air separation unit for separating oxygen and nitrogen from the air.

An electric energy end of the air separation unit is connected with the electric energy end of the grid-connected end 8, wherein the electricity is only supplied by the renewable energy power generation device 1 when the power supply of the renewable energy power generation device is stable, and the electricity may be supplied by the electric energy generated by the turbine power generation device 6 when the power supply of the renewable energy power generation device 1 is unstable. An oxygen output end of the air separation unit is connected with an input end of the hydrogen-oxygen combustion device 5 for providing the oxygen required for combustion. A first nitrogen output end of the air separation unit is connected with a nitrogen input end of the ammonia synthesis device 7 for providing the nitrogen required, and a second nitrogen output end of the air separation unit is connected with the turbine power generation device 6.

In the embodiment, in order to make the turbine power generation device 6 satisfy both expansion and power generation by using the high-temperature and high-pressure gas and expansion and power generation by using the normal-temperature and high-pressure oxygen, the turbine power generation device 6 may include a turbine machine (specifically, a four-stage turbine device), a nitrogen replacement device 14 and a nitrogen thermal management device 15.

A compressed gas inlet of the turbine machine is connected with an output end of the hydrogen-oxygen combustion device 5 and the second output end of the oxygen storage unit 4 for receiving the high-temperature and high-pressure gas or the normal-temperature and high-pressure oxygen.

Input ends of the nitrogen replacement device 14 and the nitrogen thermal management device 15 are connected with the second nitrogen output end of the air separation unit, respectively. An output end of the nitrogen replacement device 14 is connected with the compressed gas inlet of the turbine machine for replacing gas in the turbine machine. An output end of the nitrogen thermal management device 15 is connected with a rotor and a casing 16 of the turbine machine for adjusting a rotational-static clearance of the turbine machine.

The reason for providing the nitrogen replacement device 14 is: oxygen is used as a combustion aid in the operation mode of pure oxygen expansion, and the substance is more likely to burn in high-pressure pure oxygen; therefore, in consideration of safety, the nitrogen replacement process is carried out before the operation of the high-pressure oxygen working fluid to ensure that no other substances exist in the turbine power generation unit 6 during the pure oxygen expansion process. In the process of the operation mode of expansion and power generation by using pure oxygen with the turbine power generation device 6, the device may further close the oxygen intake chamber, and simultaneously open a valve 14 of the nitrogen replacement device to fill in nitrogen to protect the operation of the unit or avoid expansion of the accident when the system considers that the turbine power generation device 6 deviates from the design state or is in an accident state.

In the embodiment, the turbine machine includes the casing 16, a Vane carrier 17, and a rotor shaft 19.

The Vane carrier 17 is disposed in the casing 16, the Vane carrier 17 forms a turbine chamber, and a hollow chamber 18 is formed between the Vane carrier 17 and the casing 16. A plurality of stationary blades are arranged at intervals in the Vane carrier 17 and cooperate with each other to form a plurality of rotor blade accommodating cavities.

A head end of the casing 16 is provided with the compressed gas inlet connected with the turbine chamber.

The rotor shaft 19 is rotatably connected in the turbine chamber through a first bearing end 21 and a second bearing end 22. The rotor shaft 19 is provided with rotor blades 24 corresponding to the rotor blade accommodating cavities.

A rotational-static clearance is formed between a tip of the rotor blade 24 and an inner wall surface of the turbine chamber, and between a bottom of the stationary blade and the rotor shaft 19.

The hollow chamber 18 is connected with the output end of the nitrogen thermal management device 15 for outputting nitrogen at a corresponding temperature to control a thermal expansion and contraction volume of the casing 16 and the Vane carrier 17, so as to adjust the rotational-static clearance between the inner wall surface of the turbine chamber and the tip of the rotor blade 24.

The rotor shaft 19 is provided inside with a rotor hollow chamber 20, the first bearing end 21 is provided with a gas channel 23 connected with the rotor hollow chamber 20, and an input end of the gas channel 23 is connected with the output end of the nitrogen thermal management device for outputting nitrogen at the corresponding temperature to control a thermal expansion and contraction volume of the rotor shaft 19 so as to adjust the rotational-static clearance between the tip of the rotor blade 24 and the inner wall surface of the turbine chamber and between the bottom of the stationary blade and the rotor shaft 19.

The above nitrogen thermal management device 15 may be divided into two parts, wherein one part is a heat management system for the rotor system, and the other part is a heat management system for the casing 16 and the carrier system.

The rotor part is mainly designed by an air-inducing structure of the rotor shaft 19, and a flow path structure of the rotor hollow chamber 20, and the nitrogen thermal management device 15 may actively control the nitrogen temperature while being adapted to different operating modes of the turbine power generation device 6, so that the nitrogen with different temperatures and flow combinations is introduced to actively control the rotation-static clearance of the turbine.

In the operation mode of expansion by using the high-temperature and high-pressure gas after hydrogen-oxygen combustion, the low-temperature nitrogen passes through the air-inducing structure of the rotor shaft 19 and enters the rotor hollow chamber 20 for cooling, thereby reducing the temperature of the rotor, actively controlling the rotor-static clearance of the turbine, and reducing the thermal stress of the rotor. In the operation mode of expansion by using the high-pressure and normal-temperature pure oxygen, the high-temperature nitrogen passes through the air-inducing structure of the rotor shaft 19 and enters the rotor hollow chamber to heat the rotor to ensure the expansion of the rotor, actively controlling the rotation-static clearance, and improve the operating efficiency of the whole machine.

The heat management system for the casing 16 and the carrier system is mainly based on the structure of the casing 16 and the carrier, wherein the nitrogen thermal management device 15 may actively control the nitrogen temperature while being adapted to different operation modes of the turbine power generation device 6, and the nitrogen with different temperatures and flow combinations is introduced into the hollow chamber 18 between the Vane carrier 17 and the casing 16 to actively control the deformation of the carrier and the blades, thereby actively controlling the rotation-static clearance of the turbine.

In the operation mode of expansion by using the high-temperature and high-pressure gas after hydrogen-oxygen combustion, the low-temperature nitrogen passes into the hollow chamber 18 between the turbine Vane carrier 17 and the casing 16 to cool the carrier, reducing the temperature of the carrier and the stator, and actively control the turbine rotation-static clearance. In the operation mode of expansion by using the high-pressure and normal-temperature pure oxygen, the high-temperature nitrogen passes through the hollow chamber 18 between the turbine Vane carrier 17 and the casing 16 to heat the carrier and the stator to ensure the expansion of the stator, actively control the rotation-static clearance, and improve the operating efficiency of the whole machine.

In the embodiment, considering the operation mode of the turbine power generation device 6, the materials, such as the rotor blade 24 and the rotor shaft 19, are all nickel-based materials, which are hardly oxidized.

In the embodiment, both the first bearing end 21 and the second bearing end 22 are provided with an active clearance control system including a hydraulic fine-tuning system and a bearing chamber oil feeding and recirculating system. A front shaft head of the rotor shaft 19 may be designed as an H-shaped shaft head, and may be designed with main and auxiliary bearings. At the same time, the main bearing (the first bearing end 21) adopts a tilting-pad bearing, and the thrust is applicable to a wide range.

The first bearing end 21 and the second bearing end 22 are provided with the hydraulic fine-tuning system, which may slightly adjust the axial position of the rotor shaft 19 during operation to adapt to the clearance conditions of different operation modes. At the same time, the bearing chamber oil feeding and recirculating system is equipped for outputting a lubricating oil with a stable temperature to maintain the working environment temperature of the bearings in the first bearing end 21 and the second bearing end 22.

In the embodiment, a front side and a rear side of the first bearing chamber of the first bearing end 21 are respectively provided with a graphite ring sealing structure, cooperated with nitrogen sealing to form better sealing performance and strong adaptability in temperature, and the gas channel 23 is located between the graphite ring sealing structures on the front side and the rear side.

The rotor shaft 19 may adopt a drum-type welded rotor, with an integrated rotor design, so that there is no leakage between the rotor discs and there are good torsion transmission characteristics.

A second bearing chamber of the second bearing end 22 is provided with a labyrinth sealing structure on a side close to the turbine chamber and the graphite ring sealing structure on a side away from the turbine chamber respectively, and the labyrinth sealing structure is used to adjust a gap between the labyrinth sealing structure and the rotor shaft 19 to control mass flow in the rotor hollow chamber 20; the graphite ring sealing cooperates with the nitrogen sealing, which has good sealing performance.

In the embodiment, the air separation unit may specifically include a liquid air separation device 9, a first air-pressure booster 10, a second air-pressure booster 12, a liquid oxygen evaporator 11, and a liquid nitrogen evaporator 13.

A liquid oxygen output end of the liquid air separation device 9 is provided with the first air-pressure booster 10 and the liquid oxygen evaporator 11 in sequence, and an output end of the liquid oxygen evaporator 11 is connected with the input end of the hydrogen-oxygen combustion device 5. A liquid nitrogen output end of the liquid air separation device 9 is provided with the second air-pressure booster 12 and the liquid nitrogen evaporator 13 in sequence, and an output end of the liquid nitrogen evaporator 13 is connected with the nitrogen input end of the ammonia synthesis device 7 and the turbine power generation device 6 respectively.

The liquid air separation device 9 may gradually separate the components in the liquid air, and finally transport the separated oxygen, nitrogen, argon, carbon dioxide, etc., to a client as industrial gas, and the separated liquid oxygen and liquid nitrogen may also be used by the energy storage system when needed.

The two boosters are used to store and use liquid oxygen and liquid nitrogen under a certain pressure, and the pressure needs to be raised to the design pressure through the boosters.

The liquid oxygen evaporator 11 may convert high-pressure liquid oxygen into high-pressure gaseous oxygen through measures such as independent heat input, waste heat utilization of turbine exhaust, and waste heat utilization of ammonia synthesis. The high-pressure gaseous oxygen may be sent to the hydrogen-oxygen combustion device 5 to be completely burnt with the green hydrogen, and the high-temperature gas is sent to the turbine power generation device 6 to generate the electricity.

The liquid nitrogen evaporator 13 may convert high-pressure liquid nitrogen into high-pressure gaseous nitrogen through measures such as independent heat input, waste heat utilization of turbine exhaust, and waste heat utilization of ammonia synthesis. The high-pressure gaseous nitrogen may be sent to the ammonia synthesis unit 7 to react with the green hydrogen to prepare the green ammonia. The high-pressure gaseous nitrogen may also be sent to the turbine power generation unit 6 to supplement the required nitrogen for the nitrogen replacement device 14 and the nitrogen thermal management device 15.

In the embodiment, the hydrogen-oxygen combustion device 5 mainly adopts advanced hydrogen-oxygen combustion technology, wherein the combusted water vapor is completely mixed with the high-pressure and normal-temperature oxygen, and the ratio in the mixed combustion of hydrogen and oxygen is precisely controlled based on the characteristics of the turbine power generation device 6, so as to match the electric energy load required by the energy storage system and achieve a highly-efficient energy storage system with zero emissions. The device includes a burner 26, an axial hydrogen nozzle 27, a radial hydrogen nozzle 28, a flame tube 29, and a blender 25.

The relationships in the structure are: the flame tube 29 is disposed in the burner 26, the interior of the flame tube 29 is a flame combustion area, an oxygen inflow channel is formed between the flame tube 29 and an inner wall of the burner 26, and an input end of the oxygen inflow channel is connected with the first output end of the oxygen storage unit 4.

An input end of the axial hydrogen nozzle 27 is connected with the second output end of the hydrogen storage unit 3, and an output end of the axial hydrogen nozzle 27 passes through the burner 26 to extend into the flame combustion area. An input end of the radial hydrogen nozzle 28 is connected with the second output end of the hydrogen storage unit 3, an output end of the radial hydrogen nozzle 28 passes through the burner 26 to extend into the flame combustion area, and the radial hydrogen nozzle 28 is disposed around the axial hydrogen nozzle 27.

An output end of the radial hydrogen nozzle 28 forms a first injection area in the flame tube 29, the output end of the axial hydrogen nozzle 27 forms a second injection area in the flame tube 29, and the first injection area is closer to a head end of the flame tube 29 relative to the second injection area in an axial direction. The flame tube 29 is provided with an oxygen output hole connected with the first injection area and an oxygen output hole of the oxygen inflow channel.

A high-temperature gas input end of the blender 25 is connected with an output end of the flame tube 29, an oxygen input end of the blender 25 is connected with the first output end of the oxygen storage unit 4, and an output end of the blender 25 is connected with the first input end of the turbine power generation device 6.

The main features of the oxygen-hydrogen combustion device 5 of the embodiment are as follows:

Staged combustion: The design of staged combustion enables fuel to enter the main (axial) secondary (radial) nozzles through two different channels inside and outside. After the radial H2 is injected, it undergoes a pre-combustion reaction with part of the O2 to consume part of the O2 to generate H2O, and form an H2O and O2 gas atmosphere with a low O2 concentration in the peripheral direction of the combustion chamber (sudden expansion areas of the combustion chamber). Then the above is mixed with the axial H2 output by the central axial hydrogen nozzle 27 to carry out the main combustion reaction. In this way, the main fuel avoids pure oxygen combustion, and since it is lower than the chemically proper ratio, the temperature of the main flame is reduced, which is beneficial to the heat transfer design of the structure. The design of the main (axial) secondary (radial) fuel nozzles may form a small combustion cycle area in the interlayer of O2 and the axial H2 jets after the initial combustion reaction of H2, which is beneficial to ensure the stable combustion of the flame.

Counter-flow O2 channel: The counter-flow O2 channel is designed so that O2 may be fed counter-currently along the outer wall of the flame tube 29 at normal temperature, and the temperature of the wall surface of the flame tube 29 may be reduced through convective heat exchange.

The blender 25 is mainly used to mix the high-temperature gas from the burner with normal-temperature oxygen to achieve the temperature and flow for the high-temperature gas required by the turbine power generation device 6 in the energy storage system.

For the hydrogen-oxygen combustion device 5 of the embodiment, through the technical characteristics of staged combustion and the design of counter-flow oxygen channel, it may ensure that the temperature field of the burner is evenly distributed and meet the resistance characteristics of existing materials.

The primary control logics for the hydrogen-oxygen combustion device are as follows:

1. Based on the pressure of the input hydrogen and oxygen, and the electric energy load gap required by the energy storage system, i.e., the required power in power generation of the turbine power generation device 6, the required inlet mass flow rate and temperature of the turbine power generation device 6 are determined.

2. Based on the reaction process of complete combustion of hydrogen and oxygen and the cooling design of the burner, the outlet temperature of the burner is determined.

3. Based on the outlet temperature of the burner and the required inlet temperature of the turbine power generation device 6, the mass flow rate for the blended of high-pressure pure oxygen is determined, thereby achieving the mass flow rate and temperature for the outlet high-temperature gas of the hydrogen-oxygen combustion device 5 required by the turbine power generation device.

The flow of the energy storage system based on hydrogen-oxygen combustion technology according to the embodiment is further described as follows.

1. When the renewable energy is running stably, the electricity is supplied to the water electrolysis device for hydrogen production 2 and the liquid air separation device 9, and the grid may be connected if there is excess electric energy;

2. The products of electrolyzed water are hydrogen and oxygen, and the main product hydrogen may be stored for a long time and sent to the ammonia synthesis unit 7 with the high-pressure nitrogen in the system to prepare green ammonia or sent to a pipeline network for, e.g., providing hydrogen for biosynthesis, using hydrogen to produce ammonia, transporting to hydrogen refueling stations, SAF and other related downstream users;

3. The by-product oxygen may be stored for a long time through the oxygen storage tank, and when the renewable energy is insufficient in supply and has fluctuated loads, or when there is an excess electric energy that needs to be connected to the grid, the flexible, zero-pollution and high-efficiency energy storage regulation are achieved by adjusting the ratio in blended combustion of hydrogen and oxygen to control the power and duration in the power generation of the energy storage system;

4. When the space for oxygen storage is full, the by-product oxygen generated in the process of electrolyzing water may also be directly used for expansion and power generation or grid-connected power generation, thereby reducing the power consumption in preparation for hydrogen with the water electrolyzing unit;

5. The liquid air separation device 9 may gradually separate the components in the liquid air, and transport the separated oxygen, nitrogen, argon, carbon dioxide, etc. to a client as industrial gas, and the separated liquid oxygen and liquid nitrogen may also be used by the energy storage system when needed; after the liquid nitrogen may be pressurized by the booster, it enters the liquid nitrogen evaporator 13 to become the high-pressure gaseous nitrogen, one part of which may be transported to the ammonia synthesis device 7 for the preparation of green ammonia; the other part may be sent to the turbine power generation unit 6 to supplement the required nitrogen for the nitrogen replacement device 14 and the nitrogen thermal management device 15.

6. The by-product liquid oxygen of the liquid air separation device 9 may be pressurized by the booster to enter the liquid oxygen evaporator 11 to become the high-pressure gaseous oxygen for long-time energy storage, or may be sent to the hydrogen-oxygen combustion device 5 together with green hydrogen for complete combustion, wherein the high-temperature gas is sent to the turbine power generation device 6 for power generation and peak regulation.

### Embodiment Two

The embodiment provides an operation method, which is applied to the energy storage system based on hydrogen-oxygen combustion technology according to Embodiment 1.

When the generating capacity of the renewable energy power generation system is stable and meets an electric energy load of the water electrolysis device for hydrogen production 2 and the liquid air separation device 9, and when the external power grid does not need peak regulation, the renewable energy power generation system supplies the electricity independently, the hydrogen and the oxygen generated by the water electrolysis device for hydrogen production 2 are respectively stored in the hydrogen storage unit 3 and the oxygen storage unit 4 for long-term storage, and the hydrogen in the hydrogen storage unit 3 may be output to the external hydrogen demand end.

When the generating capacity of the renewable energy power generation system is stable and meets the electric energy load of the water electrolysis device for hydrogen production 2 and the liquid air separation device 9, and when the external power grid needs peak regulation, the renewable energy power generation system supplies the electricity for the water electrolysis device for hydrogen production 2, and the turbine power generation device 6 selects the high-temperature and high-pressure gas after hydrogen-oxygen combustion for expansion and power generation or a high-pressure normal-temperature pure oxygen output from the oxygen storage unit 4 for expansion and power generation according to a peak regulating load and outputs the electric energy to the grid-connected end 8.

When the generating capacity of the renewable energy power generation system is stable and does not meet the electric energy load of the water electrolysis device for hydrogen production 2 and the liquid air separation device 9, the renewable energy power generation system and the turbine power generation device 6 supply the electricity simultaneously, the hydrogen storage unit 3 and the oxygen storage unit 4 output the hydrogen and the oxygen to the hydrogen-oxygen combustion device 5 for combustion to form the high-temperature and high-pressure gas, and the turbine power generation device 6 receives the high-temperature and high-pressure gas for expansion and power generation to supplement a remaining electric energy load required by the water electrolysis device for hydrogen production 2.

When the generating capacity of the renewable energy power generation system is stable and does not meet the electric energy load of the water electrolysis device for hydrogen production 2 and the liquid air separation device 9, the renewable energy power generation system and the turbine power generation device 6 supply the electricity simultaneously, and the oxygen storage unit 4 outputs the high-pressure and normal-temperature pure oxygen to the turbine power generation device 6 for expansion and power generation to supplement the remaining electric energy load required by the water electrolysis device for hydrogen production 2.

When the generating capacity of the renewable energy power generation system is not stable, the turbine power generation device 6 supplies the electricity for the water electrolysis device for hydrogen production 2 and the liquid air separation device 9, the hydrogen storage unit 3 and the oxygen storage unit 4 output the hydrogen and the oxygen to the hydrogen-oxygen combustion device 5 for combustion to form the high-temperature and high-pressure gas, and the turbine power generation device 6 receives the high-temperature and high-pressure gas for expansion and power generation and outputs the electric energy to the water electrolysis device for hydrogen production 2.

Application Cases

The energy storage system based on hydrogen-oxygen combustion technology according to Embodiment 1 is further described with a part of application cases as follows.

An energy storage device uses a wind turbine to convert wind energy into electrical energy. The rated full power generation load scale of wind power is 150 MW, the rated power consumption of the water electrolysis device for hydrogen production 2 and liquid air separation device 9 downstream is 120 MW, and the hydrogen production per hour is 1.7 W Nm\hat{ }3.

1. When the wind power environment is in a stable state, the power consumed by the water electrolysis device for hydrogen production and liquid air separation device 9 is provided by the wind power generation system.

2. When the wind environment is stable, but the wind power system may only provide 90 MW of electric energy, in order to maintain the stable operation of the energy storage system, the fuel may be provided to the hydrogen-oxygen combustion device 5 by the hydrogen storage tank and the oxygen storage tank in the water electrolysis device for hydrogen production 2 according to the incomplete combustion equivalent ratio, and the hydrogen with a fuel flow rate of 0.4 kg/s and the oxygen with a mass flow rate of 140 kg/s are actively controlled by the automatic control device to be provided to the hydrogen-oxygen combustion device 5.

After the hydrogen-oxygen combustion device 5 is subjected to the reaction, the gas has parameters of a total pressure of 25 bar, a temperature of 300° C., and a mass flow rate of 140.4 kg/s, which are provided to the high-temperature and high-pressure gas of the turbine power generation device 6 for expansion and power generation. The turbine power generation device 6 may generate about 32.9 MW of shaft power, which is converted into about 30 MW of electric energy by a generator and supplied to the water electrolysis device for hydrogen production 2 and the liquid air separation device 9 to maintain the stable operation of the energy storage system.

3. When the wind environment is stable, but the wind power system may only provide 55 MW of electric energy, in order to maintain the stable operation of the energy storage system, the turbine power generation device 6 is required to provide about 70 MW of electric energy, and the oxygen storage tank in the water electrolysis device for hydrogen production 2 provides the high-pressure and low-temperature oxygen to the turbine power generation device 6 for expansion and power generation, wherein the oxygen has parameters of a total pressure of 25 bar and a temperature of 25° C., and the mass flow rate is 491 kg/s; the medium and low temperature turbine device may generate about 67.8 MW of shaft power, which is converted into about 65 MW of electric energy by the generator and supplied to the water electrolysis device for hydrogen production 2 and the liquid air separation device 9 to maintain the stable operation of the energy storage system.

4. When the power generation is performed in a windless environment, the fuel may be provided to the hydrogen-oxygen combustion and blending device by the hydrogen storage tank and the oxygen storage tank in the water electrolysis device for hydrogen production 2 according to the incomplete combustion equivalent ratio, and the hydrogen with a fuel flow rate of 1.5 kg/s and the oxygen with a mass flow rate of 298 kg/s are actively controlled by the automatic control device to be provided to the hydrogen-oxygen combustion device 5.

After the hydrogen-oxygen combustion device 5 is subjected to the reaction, the gas has parameters of a total pressure of 25 bar, a temperature of 500° C., and a mass flow rate of 299.6 kg/s, which are provided to the high-temperature and high-pressure gas of the turbine power generation device 6 for expansion and power generation. The turbine power generation device 6 may generate about 122.7 MW of shaft power, which is converted into about 120 MW of electric energy by a generator and supplied to the water electrolysis device for hydrogen production 2 and the liquid air separation device 9 to maintain the stable operation of the energy storage system.

The implementations of the present invention are described in detail above with reference to the accompanying drawings, but the present invention is not limited to the above implementations. Even if various changes are made to the present invention; if these changes fall within the scope of the claims of the invention and equivalent technologies, they still fall within the protection scope of the invention.

What is claimed is:

1. An energy storage system based on hydrogen-oxygen combustion technology, comprising:
a renewable energy power generation device;
a water electrolysis device for hydrogen production, with an electric energy input end connected with an electric energy output end of the renewable energy power generation device;
a hydrogen storage unit, with an input end connected with a hydrogen output end of the water electrolysis device for hydrogen production, and with a first output end used to be connected with an external hydrogen demand end;
an oxygen storage unit, with an input end connected with an oxygen output end of the water electrolysis device for hydrogen production;
a hydrogen-oxygen combustion device, with a hydrogen input end connected with a second output end of the hydrogen storage unit, and an oxygen input end connected with a first output end of the oxygen storage unit for mixed combustion of inputted hydrogen and oxygen and outputting a high-temperature and high-pressure gas;
a turbine power generation device, with a first input end connected with an output end of the hydrogen-oxygen combustion device for receiving the high-temperature and high-pressure gas and performing expansion to generate power, a second input end connected with a second output end of the oxygen storage unit for receiving a high-pressure oxygen output by the oxygen storage unit and performing expansion to generate power, and an electric energy output end connected with the water electrolysis device for hydrogen production;
a grid-connected end, with an electric energy input end connected with the electric energy output end of the renewable energy power generation device and the electric energy output end of the turbine power generation device respectively, and with an electric energy output end connected with an external power grid; and
an ammonia synthesis device, with a hydrogen input end connected with a third output end of the hydrogen storage unit for generating gaseous ammonia and outputting to an external ammonia demand end.

2. The energy storage system based on hydrogen-oxygen combustion technology according to claim 1, further comprising an air separation unit for separating oxygen and nitrogen from air,
wherein an electric energy end of the air separation unit is connected with the electric energy end of the grid-connected end,
wherein an oxygen output end of the air separation unit is connected with an input end of the hydrogen-oxygen combustion device, and
wherein a first nitrogen output end of the air separation unit is connected with a nitrogen input end of the ammonia synthesis device, and a second nitrogen output end of the air separation unit is connected with the turbine power generation device.

3. The energy storage system based on hydrogen-oxygen combustion technology according to claim 2, wherein the turbine power generation device comprises:
a turbine machine;
a nitrogen replacement device; and
a nitrogen thermal management device,
wherein a compressed gas inlet of the turbine machine is connected with the output end of the hydrogen-oxygen combustion device and the second output end of the oxygen storage unit,
wherein input ends of the nitrogen replacement device and the nitrogen thermal management device are connected with the second nitrogen output end of the air separation unit, respectively,
wherein an output end of the nitrogen replacement device is connected with the compressed gas inlet of the turbine machine for replacing gas in the turbine machine, and
wherein an output end of the nitrogen thermal management device is connected with a rotor and a casing of the turbine machine for adjusting a rotational-static clearance of the turbine machine.

4. The energy storage system based on hydrogen-oxygen combustion technology according to claim 3, wherein the turbine machine comprises:
the casing;
a Vane carrier; and
a rotor shaft,
wherein the Vane carrier is disposed in the casing, the Vane carrier forms a turbine chamber, and a hollow chamber is formed between the Vane carrier and the casing; a plurality of stationary blades is arranged at intervals in the Vane carrier, and the stationary blades cooperate with each other to form a plurality of rotor blade accommodating cavities,
wherein a head end of the casing is provided with the compressed gas inlet connected with the turbine chamber,
wherein the rotor shaft is rotatably connected in the turbine chamber through a first bearing end and a second bearing end; the rotor shaft is provided with rotor blades corresponding to the rotor blade accommodating cavities,
wherein the rotational-static clearance is formed between a tip of the rotor blade and an inner wall surface of the turbine chamber and between a bottom of the stationary blade and the rotor shaft,
wherein the hollow chamber is connected with the output end of the nitrogen thermal management device for outputting nitrogen at a corresponding temperature to control a thermal expansion and contraction volume of the casing and the Vane carrier, so as to adjust the rotational-static clearance between the inner wall surface of the turbine chamber and the tip of the rotor blade, and
wherein the rotor shaft is provided inside with a rotor hollow chamber, the first bearing end is provided with a gas channel connected with the rotor hollow chamber, and an input end of the gas channel is connected with the output end of the nitrogen thermal management device for outputting nitrogen at the corresponding temperature to control a thermal expansion and contraction volume of the rotor shaft so as to adjust the rotational-static clearance between the tip of the rotor blade and the inner wall surface of the turbine chamber and between the bottom of the stationary blade and the rotor shaft.

5. The energy storage system based on hydrogen-oxygen combustion technology according to claim 4, wherein the rotor blades and the rotor shaft are made of nickel-based materials.

6. The energy storage system based on hydrogen-oxygen combustion technology according to claim 4, wherein the first bearing end and the second bearing end are provided with a hydraulic fine-tuning system and a bearing chamber oil feeding and recirculating system, the hydraulic fine-tuning system is used to adjust an axial position of the rotor shaft, and the bearing chamber oil feeding and recirculating system is used to output a lubricating oil with a stable temperature to maintain a bearing operation environment temperature in the first bearing end and the second bearing end.

7. The energy storage system based on hydrogen-oxygen combustion technology according to claim 4, wherein a front side and a rear side of a first bearing chamber of the first bearing end are respectively provided with a graphite ring sealing structure, and the gas channel is located between the graphite ring sealing structures on the front side and the rear side, and
wherein a second bearing chamber of the second bearing end is provided with a labyrinth sealing structure on a side close to the turbine chamber and the graphite ring sealing structure on a side away from the turbine chamber respectively, and the labyrinth sealing structure is used to adjust a gap between the labyrinth sealing structure and the rotor shaft to control mass flow in the rotor hollow chamber.

8. The energy storage system based on hydrogen-oxygen combustion technology according to claim 2, wherein the air separation unit comprises:
a liquid air separation device;
a first air-pressure booster;
a second air-pressure booster;
a liquid oxygen evaporator; and
a liquid nitrogen evaporator,
wherein a liquid oxygen output end of the liquid air separation device is provided with the first air-pressure booster and the liquid oxygen evaporator in sequence, and an output end of the liquid oxygen evaporator is connected with the input end of the hydrogen-oxygen combustion device, and
wherein a liquid nitrogen output end of the liquid air separation device is provided with the second air-pressure booster and the liquid nitrogen evaporator in sequence, and an output end of the liquid nitrogen evaporator is connected with the nitrogen input end of the ammonia synthesis device and the turbine power generation device respectively.

9. The energy storage system based on hydrogen-oxygen combustion technology according to claim 1, wherein the hydrogen-oxygen combustion device comprises:
a burner;
an axial hydrogen nozzle;
a radial hydrogen nozzle;
a flame tube; and
a blender,
wherein the flame tube is disposed in the burner, an interior of the flame tube is a flame combustion area, an oxygen inflow channel is formed between the flame tube and an inner wall of the burner, and an input end of the oxygen inflow channel is connected with the first output end of the oxygen storage unit,
wherein an input end of the axial hydrogen nozzle is connected with the second output end of the hydrogen storage unit, and an output end of the axial hydrogen nozzle passes through the burner to extend into the flame combustion area,
wherein an input end of the radial hydrogen nozzle is connected with the second output end of the hydrogen storage unit, an output end of the radial hydrogen nozzle passes through the burner to extend into the flame combustion area, and the radial hydrogen nozzle is disposed around the axial hydrogen nozzle,
wherein an output end of the radial hydrogen nozzle forms a first injection area in the flame tube, the output end of the axial hydrogen nozzle forms a second injection area in the flame tube, and the first injection area is closer to a head end of the flame tube relative to the second injection area in an axial direction,
wherein the flame tube is provided with an oxygen output hole connected with the first injection area and an oxygen output hole of the oxygen inflow channel, and
wherein a high-temperature gas input end of the blender is connected with an output end of the flame tube, an oxygen input end of the blender is connected with the first output end of the oxygen storage unit, and an output end of the blender is connected with the first input end of the turbine power generation device.

10. An operation method, applied to the energy storage system based on hydrogen-oxygen combustion technology according to claim 1,
wherein when a generating capacity of the renewable energy power generation system is stable and meets an electric energy load of the water electrolysis device for hydrogen production, and when the external power grid does not need peak regulation, the renewable energy power generation system supplies the electricity independently, the hydrogen and the oxygen generated by the water electrolysis device for hydrogen production are respectively stored in the hydrogen storage unit and the oxygen storage unit for long-term storage, and the hydrogen in the hydrogen storage unit may be output to the external hydrogen demand end,
wherein, when the generating capacity of the renewable energy power generation system is stable and meets the electric energy load of the water electrolysis device for hydrogen production, and when the external power grid needs peak regulation, the renewable energy power generation system supplies the electricity for the water electrolysis device for hydrogen production, and the turbine power generation device selects the high-temperature and high-pressure gas after hydrogen-oxygen combustion for expansion and power generation or a high-pressure and normal-temperature pure oxygen output from the oxygen storage unit for expansion and power generation according to a peak regulating load and outputs the electric energy to the grid-connected end,
wherein, when the generating capacity of the renewable energy power generation system is stable and does not meet the electric energy load of the water electrolysis device for hydrogen production, the renewable energy power generation system and the turbine power generation device supply the electricity simultaneously, the hydrogen storage unit and the oxygen storage unit output the hydrogen and the oxygen to the hydrogen-oxygen combustion device for combustion to form the high-temperature and high-pressure gas, and the turbine power generation device receives the high-temperature and high-pressure gas for expansion and power generation to supplement a remaining electric energy load required by the water electrolysis device for hydrogen production,
wherein, when the generating capacity of the renewable energy power generation system is stable and does not meet the electric energy load of the water electrolysis device for hydrogen production, the renewable energy power generation system and the turbine power generation device supply the electricity simultaneously, and the oxygen storage unit outputs the high-pressure and normal-temperature pure oxygen to the turbine power generation device for expansion and power generation to supplement the remaining electric energy load required by the water electrolysis device for hydrogen production, and
wherein, when the generating capacity of the renewable energy power generation system is not stable, the turbine power generation device supplies the electricity for the water electrolysis device for hydrogen production, the hydrogen storage unit and the oxygen storage unit output the hydrogen and the oxygen to the hydrogen-oxygen combustion device for combustion to form the high-temperature and high-pressure gas, and the turbine power generation device receives the high-temperature and high-pressure gas for expansion and power generation and outputs the electric energy to the water electrolysis device for hydrogen production.
